(19) United States
(12) Patent Application Publication
(10) Pub. No.: US 2001/0028036 A1
(43) Pub. Date: Oct. 11, 2001

(54) Wavelength dispersive infrared detector and microspectrometer using microcantilevers

(76) Inventors: Thomas G. Thundat, Knoxville, TN (US); Patrick I. Oden, Knoxville, TN (US); Panagiotis G. Datskos, Knoxville, TN (US)

Correspondence Address: Jones & Askew, LLP, 2400 Monarch Tower, 3424 Peachtree Road, N.E., Atlanta, GA, 30326, US

(21) Appl. No.: 09/795,067

(22) Filed: Feb. 26, 2001

Related U.S. Application Data
(63) Continuation of application No. 09/047,360, filed on Mar. 25, 1998, now abandoned.

(51) Int. Cl. G01J 5/02

(52) U.S. Cl. 250/339.02

(57) ABSTRACT

A spectrum of electromagnetic radiation is detected by spatially dispersing radiation of varying wavelengths onto micromechanical sensors. As the micromechanical sensors absorb radiation, the sensors bend and/or undergo a shift in the resonance characteristics. The device can be used as a spectrometer or a temperature sensing device. A temperature sensor using micromechanical sensors can accurately and quickly measure the temperature of a remote object by sensing a spectrum of infrared radiation emitted by the object. The temperature sensor can measure temperature without knowing the emissivity of the object or the distance of the object from the detector.

This invention was made with Government support under contract DE-AC05-96OR22464 awarded by the U.S. Department of Energy to Lockheed Martin Energy Systems, Inc. and the Government has certain rights in this invention.

### FIELD OF THE INVENTION

The present invention relates generally to the field of measuring and testing, and more specifically, to the detection of electromagnetic radiation using micromechanical sensors.

### BACKGROUND OF THE INVENTION

Miniature electromagnetic radiation detectors are needed for a variety of applications. For example, miniature spectrometers are needed for field analysis and analyzing small quantities of samples and miniature infrared detectors are needed for measuring temperature in tight locations. Considerable difficulties are encountered, however, when attempting to miniaturize existing detectors.

One particularly useful application for a miniature radiation detector is for use as a temperature sensor. Every object emits infrared radiation which varies in intensity as a function of wavelength. The emitted infrared radiation spectrum is characteristic of the object's temperature. The temperature of an object can be determined by detecting the emitted infrared radiation. However, determining an accurate temperature of the object based on its emitted infrared radiation is a challenging problem when the emissivity of the object and the distance of the object from the detector is not known.

Most currently available devices produce a signal based on the intensity of the incident infrared radiation, without correcting for emissivity and distance of the temperature source from the infrared detector. Hotter objects that are far way can appear as cooler objects with respect to relatively colder objects at shorter distances.

One way of measuring absolute temperature is by measuring the intensity of infrared radiation at different wavelengths, and then correlating the intensity values to a temperature using a well known method such as that described in U.S. Pat. Nos. 5,118,200 or 5,326,173.

One way of measuring infrared radiation at multiple wavelengths is by placing different filters in front of the infrared detector. By interchanging the filters, the intensity of infrared radiation at various wavelengths can be calculated. This, however, can be slow due to the time needed for the mechanical interchange of different filters.

What is needed is a temperature detector than can be made very small, and can measure the temperature of an object accurately and quickly without knowing the emissivity of the object or its distance from the detector.

### SUMMARY OF THE INVENTION

An object of the present invention is to provide a detector which is capable of detecting a broad spectrum of electromagnetic radiation.

Another object of the present invention is to provide a detector which capable of being miniaturized while detecting electromagnetic radiation with picojoule sensitivity.

Still another object of the present invention is to provide a temperature detector that can measure the temperature of an object without knowing the emissivity of the object or the distance of the object from the detector.

These and other objects of the invention are met by providing an apparatus and method for detecting radiation comprising a dispersive element which spatially disperses radiation, at least one cantilever in a path of the spatially dispersed radiation, wherein the cantilever has at least one physical property affected by the spatially dispersed radiation.

The dispersive element may include a lens, a prism, a mirror, or a grating. For a temperature detector, the cantilever would respond to infrared radiation. The temperature can be determined based on the infrared radiation spectrum. The cantilevers may remain stationary or may be moved sequentially to a plurality of locations, wherein a measure of radiation is performed at more than one location. Alternatively, the dispersive element may be moved or rotated to change the angle of the dispersed radiation, wherein a measure of radiation is performed after a movement of the dispersive element.

The cantilevers may be arranged in a fixed array of cantilevers, wherein each cantilever detects spatially dispersed radiation dispersed at a different angle by the dispersive element.

Another embodiment of the invention is for use as a spectrophotometer. Radiation from a radiation source may be transmitted through a substance before entering the radiation dispersive element. In this case the cantilevers' response would represent a radiation absorption spectrum of the substance.

Alternatively the radiation from the radiation source may reflected off a substance before entering the radiation dispersive element. In this case the cantilevers' response would indicate a radiation reflectance spectrum of the substance.

In another specific embodiment of the invention, the cantilevers respond to spatially dispersed radiation at a focal point along a principal axis of a lens. The cantilever is approximately the same size as the diameter of a beam waist for a spatially dispersed radiation beam of a specific wavelength.

In another specific embodiment of the invention, the detector further comprises an aperture, wherein the aperture has a diameter approximately the same size as the diameter of a beam waist for a radiation beam of a desired wavelength. The aperture transmits the radiation of the desired wavelength, while blocking radiation of desired wavelengths. A cantilever may be scanned along the principal axis of a lens along with the aperture.

Other objects, advantages, and salient features will be more apparent when considered with the following detailed description and drawing that are provided to facilitate the understanding of the subject invention without any limitation thereto.

### BRIEF DESCRIPTION OF THE DRAWING

FIG. 1 is a schematic view of a radiation detector utilizing an array of cantilevers and a prism according to an embodiment of the present invention.

FIG. 2 is an enlarged, perspective view of an individual cantilever.

FIG. 3 is a schematic view of an embodiment of a radiation detector utilizing a lens and a microcantilever array.

FIG. 4 is a schematic view of a radiation detector utilizing an aperture.

FIG. 5 is a schematic view of an embodiment of the present invention for use as a spectrophotometer.

### DETAILED DESCRIPTION OF THE PREFERRED EMBODIMENTS

For a better understanding of the present invention, together with other and further objects, advantages, and capabilities thereof, reference is made to the following disclosure and to the figures of the drawing, where like reference characters designate like or similar elements. In accordance with an embodiment of the invention, radiation detection over a range of wavelengths is based upon absorption of radiation to cause physical movement and changes in the mechanical resonance of a microcantilever.

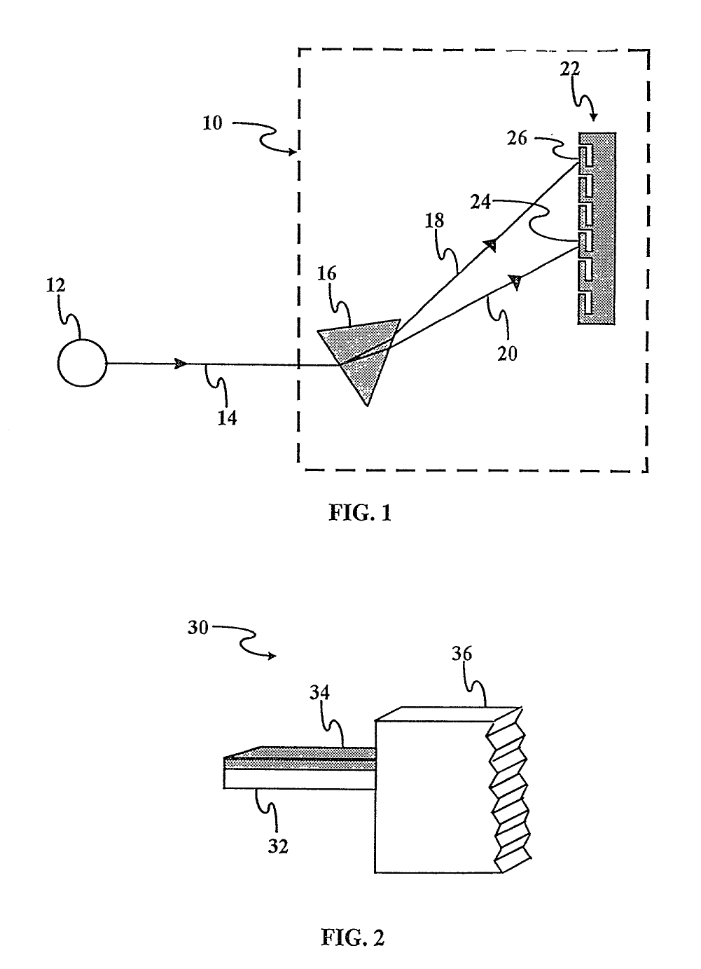

Referring to FIG. 1, a detector according to the present invention is generally referred to by the numeral 10. A radiation source 12 outputs radiation 14 which impinges upon dispersive element 16. Dispersive element 16 spatially disperses incident radiation 14. Dispersive element 16 may be a prism, a lens, a diffraction grating, or other element which spatially disperses incident radiation. Dispersive element 16 may also include a combination of elements such as a combination of lenses, mirrors, prisms, and/or gratings.

The radiation outputted from dispersive element 16 impinges upon microcantilever array 22 comprised of individual microcantilevers which respond to incident radiation. The description of a microcantilever which detects electromagnetic and nuclear radiation and methods for detection of microcantilever response are the subject of U.S. Pat. No. 5,445,008 and copending U.S. patent application Ser. No. 08/588,484 (filed Jan. 18, 1996), which are incorporated by reference herein.

FIG. 1 shows two exemplary rays outputted from dispersive element 16: rays 18 and 20. Ray 18 has wavelength λ₁ and ray 20 has wavelength λ₂. Ray 18 impinges upon individual microcantilever 26, which consequently responds to the intensity of radiation of wavelength λ₁. Output ray 20 impinges upon individual microcantilever 24, which consequently responds to the intensity of radiation of wavelength λ₂.

By detecting the response of the individual microcantilevers to the impinging radiation, the intensity of the radiation over a range of wavelengths can be measured, and hence allows one to measure the intensity spectrum of the radiation source 30, and obtain the shape of the radiation intensity profile.

The microcantilever array 22 may be a one, two, or three dimensional array of microcantilevers. As an alternative to a fixed array of microcantilevers 22, the detector 10 may instead utilize one or more microcantilevers which are moved sequentially to different positions or scanned along an axis to detect the intensity of radiation of different wavelengths. For example, a single microcantilever could be moved to the position occupied by individual microcantilever 26 in FIG. 1, to measure the intensity of radiation with wavelength λ₁, and subsequently the same microcantilever could then be moved to the position occupied by microcantilever 24, to measure radiation of wavelength λ₂. Alternatively, one or more microcantilevers can remain fixed in one location, while the dispersive element is moved or rotated to change the angle of the dispersed radiation.

Referring to FIG. 2, one form of a microcantilever radiation sensor is generally referred to by the numeral 30. The sensor 30 includes a microcantilever 32 connected at its proximal end to, and extending outwardly from, a base 36. The microcantilever is coated with one or more coating materials 34 that react to electromagnetic radiation. As the coatings on the microcantilever absorb electromagnetic radiation, the microcantilever bends, and/or undergoes a shift in resonance frequency.

The primary advantages of using microcantilevers is their very high sensitivity, since microcantilever motion can be detected with subnanometer precision, and the ability to fabricate microcantilevers into a multi-element sensor array. Microcantilever elements that are made bimetallic or bimaterial are extremely sensitive to changes in temperature and undergo bending due to differential thermal expansions of different members of the bimaterial system. The sensitivity of a bimaterial cantilever can be increased by choosing the members of the bimaterial system such that the differential thermal expansion is optimum. This can be easily achieved by coating a silicon microcantilever with a metal overlayer. Using such an arrangement, temperature changes as small as 10⁻⁶° C. or heat changes on the order of a femto-Joule can be detected by measuring the changes in the cantilever bending.

Coating one side of a microcantilever with a different material, such as metal film, makes the microcantilever sensitive to temperature variations due to the bimetallic or bimaterial effect resulting in cantilever bending. The bending of the microcantilever is proportional to the heat energy absorbed by the microcantilever. The maximum microcantilever deflection, zₘₐₓ, due to differential stress induced by incident heat energy on the bimaterial cantilever is given by:

$${z}_{max} = \frac{5}{4} \frac{( {t}_{1} + {t}_{2} ) {l}^{3}}{( {λ}_{1} {t}_{1} + {λ}_{2} {t}_{2} ) {wt}_{2}^{2}} \cdot \frac{( {α}_{1} - {α}_{2} ) ( dQ / dt )}{4 ( 1 + {t}_{1}^{2} / {t}_{2}^{2} ) + 1 / {t}_{1} {t}_{2} ( 6 {t}_{1}^{2} + {E}_{1} {t}_{2}^{2} / {E}_{2} ) + {E}_{1} {t}_{1}^{3} / {E}_{2} {t}_{2}^{3}} \qquad ( 1 )$$

Where dQ/dt is the incident heat energy, 1 and w are the length and width of the microcantilever, respectively, t₁ and t₂ are the thicknesses of the two layers, λ₁ and λ₂ are the thermal conductivities, α₁ and α₂ are the thermal expansion coefficients, and E₁ and E₂ are the Young's moduli of elasticity of the two layers.

In addition to bending, the microcantilever can also respond to changes in temperature by a shift in resonance frequency. The resonance frequency, f, of an oscillating cantilever can be expressed as:

$$f = \frac{1}{2 π} \sqrt{\frac{k}{{m}^{*}}} \qquad ( 2 )$$

where k is the spring constant of the lever and m* is the effective mass of the microcantilever.

The spring constant of a microcantilever can change due to changes in heat. This can be due to surface stress as in the case of bimaterial effect or changes in physical dimensions. The change in spring constant δk of the cantilever can be calculated from the bending of the cantilever as follows:

$$δ k = {π}^{2} n \frac{( δ {s}_{1} - δ {s}_{2} )}{4 {n}_{1}} \qquad ( 3 )$$

where δs₁ and δs₂ are the stresses on the cantilever surfaces and n is a constant and n₁ is a geometrical constant.

Since the spring constant of a microcantilever is related to physical dimensions, the resonance frequency can also change due to changes in dimensions. The resonance frequency of a cantilever is directly proportional to the square root of the width and cube root of the thickness. The resonance frequency varies inversely as the cube root of length.

The bending of a cantilever can be measured with sub-angstrom resolution using various techniques. Examples include: (1) detecting changes in intensity of a reflected beam of a laser diode focused at the end of the microcantilever using a position sensitive detector, (2) detecting the variation in the piezoresistance of a boron implanted channel in a silicon microcantilevers, (3) detecting changes in capacitance between microcantilever and a fixed surface, and (4) detecting variation in the piezoelectric voltage of piezoelectric film on a microcantilever. The need for an optical set up can be eliminated by using one of the electrical detection schemes discussed above. The resonance frequency variation of the microcantilever can be detected using the same techniques discussed above.

The invention shown in FIG. 1 is particularly useful to measure the spectrum of infrared radiation due to the large refractive and dispersive properties of certain materials in the infrared region. The detector 10 can measure the temperature of an object by measuring the infrared radiation spectrum emitted by that object. Since the intensity spectrum over a range of wavelengths can be measured, the peak of the infrared profile can be determined, and the temperature of the object can be determined using a well-known method without knowing the emissivity of the object.

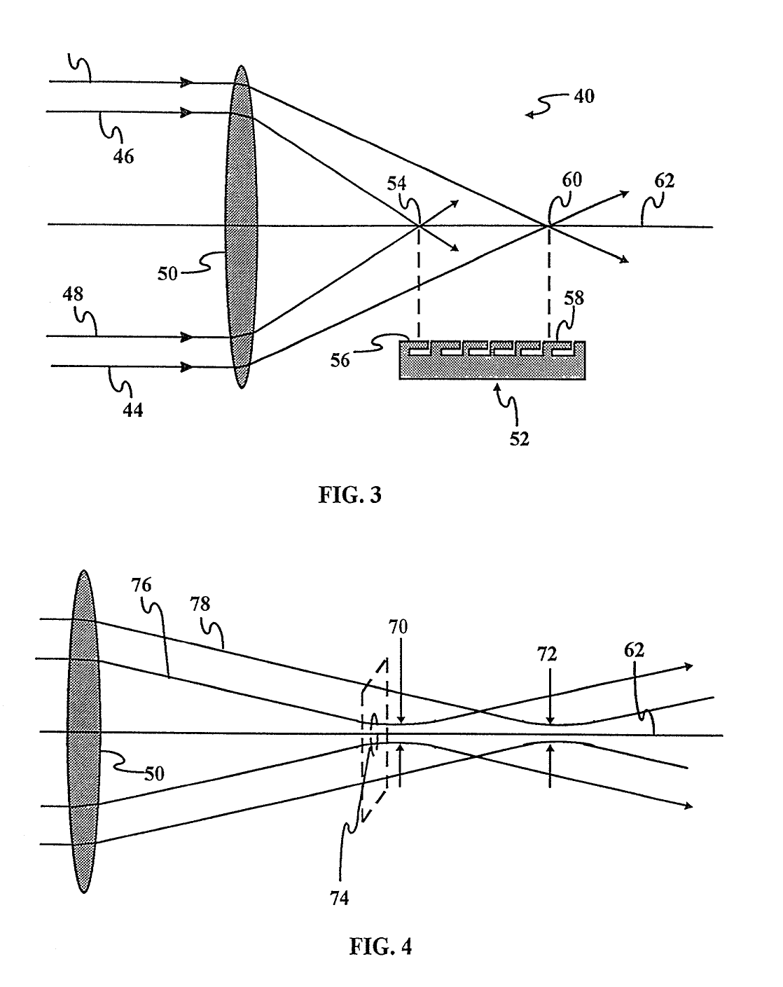

FIG. 3 depicts an embodiment of the present invention which utilizes a lens 50 as the dispersive element. As shown in FIG. 3, lens 50 refracts incoming parallel radiation to various focal points along the principal axis 62. The location of the focal point varies as a function of wavelength of the incoming radiation. For an aberrant, convex-concave, refracting lens with refractive index n(λ) and with radii of curvature R₁ and R₂, the focal length f(λ) is given by:

$$f ( λ ) = \frac{1}{n ( λ ) - 1} \frac{{R}_{1} {R}_{2}}{{R}_{1} + {R}_{2}} \qquad ( 4 )$$

where n is the refractive index, and R₁ and R₂ are the radii of curvature of the lens. Focal point f(λ) refers to the focal point for incident radiation of wavelength λ. The distance between focal lengths for radiation of different wavelengths can also be calculated using the above equation.

FIG. 3 depicts exemplary rays 42 and 44, which both have a wavelength λ₁. Exemplary rays 46 and 48 both have a wavelength λ₂. The lens refracts rays 46 and 48 into focal point 54 and the lens refracts rays 42 and 44 into focal point 60. By positioning the microcantilever array 52 along the principal axis 62 such that individual microcantilever 56 is located at focal point 54, then individual microcantilever 56 will respond to impinging rays 46 and 48, and consequently measure the intensity of radiation of wavelength λ₂. Similarly, microcantilever 58 will measure the intensity of impinging rays 42 and 44, with wavelength λ₁.

If the difference between wavelengths λ₁ and λ₂ is small, then focal points 54 and 60 will be close together on the principal axis 62. For smaller Δ=λ₁−λ₂, focal points 54 and 60 will be closer together. For very small Δ, it may be difficult to distinguish separate signals for λ₁ and λ₂. The ability of the microcantilever detector to distinguish separate signals when Δ is small improves when the microcantilevers are more finely spaced, but worsens with a larger focus spot size of the radiation.

One method for improving the ability of the detector to distinguish signals with a small Δ, is to use an aperture located at the focal point. FIG. 4 depicts two beams of radiation, 76 and 78, passing through lens 50. Photons of wavelength λ₂ form beam 76 while photons of wavelength λ₁ form beam 78. The beam 76 is the narrowest at the beam waist 70. The photons of wavelength λ₂ pass through the beam waist 70. Similarly, photons of wavelength λ₁ form beam 78 and pass through beam waist 72.

To best detect the intensity of a radiation signal with wavelength λ₂, a microcantilever should be positioned at beam waist 70, and the size of the detector should be approximately equal to the diameter of the beam waist. In this way it can minimize the effect from other wavelengths. An aperture 74 with a diameter approximately equal to the diameter of the beam waist 70 may be placed at beam waist 70, so that most of the radiation passing through the aperture 74 will be due to radiation of wavelength λ₂. Similarly, an aperture with a diameter approximately equal to the diameter of beam waist 72 may be placed at beam waist 72, and most of the radiation passing through that aperture will be due to radiation of wavelength λ₁. The diameter of the aperture should approximately equal the diameter of the beam waist, which is given by:

$$w = \frac{2 λ}{π} ( \frac{f ( λ )}{D} ) for f ( λ ) / D ⪢ 1 \qquad ( 5 )$$

where w is the diameter of the beam waist, D is the diameter of the lens, and f(λ) is the wavelength dependent focus of the lens.

The aperture 74 and a microcantilever may be joined to form a detector assembly and then scanned along the principal axis 62. By sampling the radiation intensity as it scans along the principal axis 62, it can measure the intensity profile of the source. The curve may be plotted by recording data points along the principal axis 62. In the case of infrared radiation, the peak of the profile can be used to calculate the temperature of the source.

The system can be further optimized by designing the lens such that focal points for wavelengths of interest are sufficiently separated along the principal axis 62. From Equation (4) it is clear that the focal-length variation depends on refractive index n and radii of curvature of the lens R₁ and R₂. Therefore, focal distances may be adjusted by appropriate selection of these parameters.

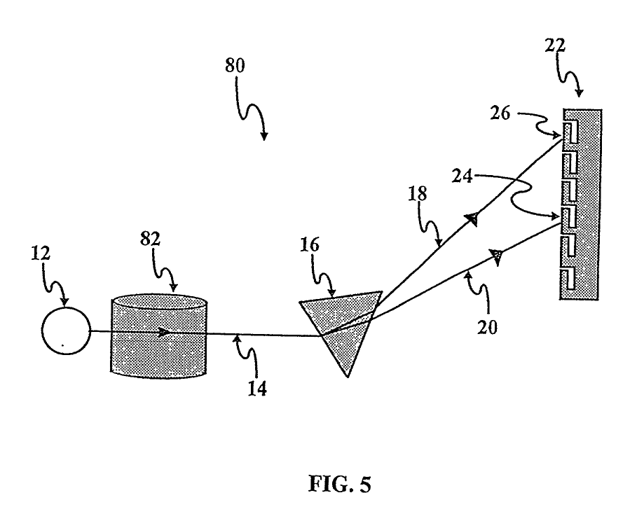

One application for the present invention is for use as a spectrophotometer as shown in FIG. 5. A spectrophotometer measures the transmission or reflectance of radiation as a function of wavelength, permitting accurate analysis of color. FIG. 5 depicts an exemplary spectrophotometer 80. A sample 82 of a gas, a liquid, or any material which partially transmits radiation is placed between the radiation source 12 and the dispersive element 16. As the radiation passes through sample 82, the attenuation of the transmitted radiation will vary as a function of radiation wavelength. Microcantilever array 22 thus can measure the spectrum profile of the transmitted radiation, and hence determine the absorption characteristics of the sample.

A reference spectrum can be generated by measuring the microcantilever response without the sample present. The difference between the spectrum with the sample present and the spectrum without the sample present represents the absolute absorption spectrum for the sample.

In an alternative spectrophotometer arrangement, the sample 82 may be placed between dispersive element 16 and the microcantilever array 22. The sample 82 may also be placed directly on the microcantilever array. If a single microcantilever is used instead of an array of microcantilevers, then the sample can be placed on the microcantilever as it is scanned across the radiation.

The lens configuration in FIG. 3 can also be used as a spectrophotometer. The sample can be placed in a stationary position on either side of the lens, or can be placed on the microcantilever array 52. If an arrangement is used where a microcantilever is attached to an aperture and scanned along the principal axis of the lens, then the sample may be placed directly on the microcantilever.

In an alternate embodiment of a spectrophotometer, instead of transmitting the radiation through a sample, the radiation may be reflected from a sample by the use of an appropriate optical arrangement. The radiation measured by the detector then represents the reflectance characteristics rather than the absorption characteristics of the sample.

While several particular forms of the invention have been illustrated and described, it will be apparent that various modifications can be made without departing from the spirit and scope of the invention.

What is claimed is:

1. An apparatus that detects radiation, comprising:
a dispersive element which spatially disperses radiation; and
at least one cantilever, being in a path of the spatially dispersed radiation, wherein the at least one cantilever has at least one physical property affected by the spatially dispersed radiation.

2. The apparatus according to claim 1, wherein the dispersive element includes a lens, a prism, a mirror, or a grating.

3. The apparatus according to claim 1, wherein the at least one cantilever being affected by infrared radiation.

4. The apparatus according to claim 3, wherein the at least one cantilever indicates a temperature correlated to a spectrum of the infrared radiation.

5. The apparatus according to claim 1, wherein the at least one cantilever indicates a spectrum of the spatially dispersed radiation.

6. The apparatus according to claim 1, wherein the at least one cantilever being moved sequentially to a plurality of locations, wherein a measure of radiation is performed at each location.

7. The apparatus of claim 1, wherein the dispersive element being moved or rotated to change an angle of the dispersed radiation.

8. The apparatus of claim 1, wherein the at least one cantilever being an array of cantilevers, and, wherein each cantilever detects spatially dispersed radiation dispersed at a different angle by the dispersive element.

9. The apparatus of claim 1, further comprising a radiation source.

10. The apparatus of claim 9, wherein radiation from the radiation source being transmitted through a substance before entering the radiation dispersive element.

11. The apparatus of claim 10, wherein the at least one cantilevers indicates a radiation absorption spectrum of the substance.

12. The apparatus of claim 9, wherein radiation from the radiation source is reflected off a substance before entering the radiation dispersive element.

13. The apparatus of claim 12, wherein the at least one cantilevers indicates a radiation reflectance spectrum of the substance.

14. The apparatus of claim 1, wherein the dispersive element is a lens.

15. The apparatus of claim 14, wherein the at least one cantilever responds to spatially dispersed radiation at a focal point along a principal axis of the lens.

16. The apparatus of claim 1, wherein the dispersive element spatially disperses radiation into an output beam.

17. The apparatus of claim 16, wherein the at least one cantilever is approximately the same size as a diameter of the beam waist for a spatially dispersed radiation with a wavelength.

18. The apparatus of claim 16, further comprising an aperture, wherein the aperture has a diameter approximately the same size as a diameter of the beam waist for a radiation of a specific wavelength.

19. The apparatus of claim 18, wherein the at least one cantilever is scanned along the principal axis of a lens.

20. An apparatus for detecting radiation comprising:
a dispersive element which spatially disperses radiation; and
an aperture with a diameter approximately equal to the diameter of a beam waist of a beam with a wavelength, wherein the aperture transmits radiation dispersed by the dispersive element;
a detector for measuring the intensity of radiation, wherein the detector responds to radiation transmitted by the aperture.

21. The apparatus of claim 20, wherein the aperture is moved along an axis of the dispersive element, and the radiation detector measures an intensity of radiation at a plurality of locations along the axis.

22. The apparatus of claim 20, wherein the radiation is transmitted through a substance which partially absorbs radiation.

23. The apparatus of claim 20, wherein the radiation is reflected off a substance which partially reflects radiation.

24. A method of detecting radiation, comprising the steps of:
spatially dispersing radiation produced by a radiation source;
exposing at least one cantilever to the dispersed radiation, the at least one cantilever having at least one physical property affected by radiation;
monitoring radiation-induced changes in the at least one physical property; and
correlating changes in the at least one physical property to a measure of radiation.

25. A method according to claim 24, wherein the dispersing step includes dispersing infrared radiation produced by an infrared radiation producing source.

26. A method according to claim 25, further comprising a step of indicating a temperature correlated to the infrared radiation.

27. A method according to claim 26, further comprising a step of indicating a spectrum of the spatially dispersed radiation.

28. A method according to claim 24, further comprising a step of moving the at least one cantilever to a plurality of locations, wherein the radiation intensity is measured at each location.

29. A method according to claim 24, further comprising a step of moving or rotating the dispersive element to change an angle of the dispersed radiation.

30. The method according to claim 24, further comprising an initial step of transmitting the radiation from the radiation source through a substance before entering the dispersive element.

31. The method according to claim 30, further comprising a step of indicating a radiation absorption spectrum of the substance.

32. The method of claim 24, further comprising an initial step of reflecting the radiation from the radiation source off of a substance, the radiation reflecting into the dispersive element.

33. The method according to claim 32, further comprising a step of indicating a radiation reflectance spectrum of the substance.

34. The method according to claim 24, wherein the step of spatially dispersing radiation includes a lens focusing radiation along a principal axis of the lens.

35. The method according to claim 34, wherein the lens spatially disperses radiation into an output beam.

36. The method according to claim 35, further including a step of blocking radiation which is at a distance approximately greater than a radius of the beam from the principal axis of the lens.

37. The method according to claim 34, further comprising a step of scanning the at least one cantilever along the principal axis of the lens.
